(19) United States
(12) Patent Application Publication
(10) Pub. No.: US 2018/0036649 A1
(43) Pub. Date: Feb. 8, 2018

(54) Desert water generation theory and its principle application

(71) Applicant: Kai Jiang, Brooklyn, NY (US)

(72) Inventor: Kai Jiang, Brooklyn, NY (US)

(21) Appl. No.: 15/732,136

(22) Filed: Sep. 22, 2017

(51) Int. Cl. B01D 5/00; E03B 3/40; C02F 9/00; E03B 3/28

(52) U.S. Cl. CPC B01D 5/0048; B01D 5/0054; B01D 5/009; E03B 3/28; E03B 3/40; C02F 9/00; C02F 2303/04

(57) ABSTRACT

Applicant discloses a new viewpoint and its application for the freshwater generation here: Air temperature exchanges between the inside and outside of the deserts always play an important role in the generation of freshwater in desert environment. Because this procedure is continually happening in days and nights, and the desert area is large in the world, so, the amount of the water production by this way is extent to which one could be imagined. According the viewpoint disclosed here, it will bring big benefits to take over the shortage water plight and for the development of the desert. According this doctrine, the easiest way to collect the water from the desert is just setting an impermeable layer under the dune: the fresh water should flow out. By use of artificial stacked large amount sands can also obtain the freshwater in anywhere which the changes of the temperature are big.

### CROSS-REFERENCE TO RELATED APPLICATIONS

This invention is continuation-in-part of following the prior application and also claims the benefit of U.S. provisional patent applications of: U.S. 62/495,709 (Sep. 22, 2016) and the disclosures of which are also hereby incorporated herein by references.

### Inventor: KAI JIANG

### Customer: 123977

### Mail Address: 1209 Ovington Avenue 2Fl, Brooklyn, N.Y. 11219

### Tel: 1 347 217 8533

Email: jkai39@hotmail.com

### US Classification:

### CCL: 62/93, 62/121, 62/123, 62/196.4, 62/271, 62/272, 62/285, 62/332,

### International: B01D5/008, B01D53/0407, B01D53/261, B01D53/28, B01D2257/80, C02F1/04, E03B3/28

| | | |
|---|---|---|
| US Patent References: | Inventor | Publication Date |

US Patent References

| | | |
|---|---|---|
| U.S. Pat. No. 1,816,592 | Knapen Achille | Jul. 28, 1931 |
| U.S. Pat. No. 2,138,689 | Edmund Altenkirch | Nov. 29, 1938 |
| U.S. Pat. No. 2,761,292 | Goanda Henri | Sep. 4, 1956 |
| U.S. Pat. No. 3,224,492 | Richard D. Houk | Dec. 21, 1965 |
| U.S. Pat. No. 3,872,917 | Oscar Blomgren | Mar. 25, 1975 |
| U.S. Pat. No. | Wilhelm Groth | Mar. 27, 1979 |
| 4,146,372A | | |
| U.S. Pat. No. 4,351,651 | Calice G. Courneya | Dec. 12, 1980 |
| U.S. Pat. No. | Richard J. Bailey | Jun. 1, 2010 |
| 7,726,138B2 | | |

International Patent References

| | | |
|---|---|---|
| WO2007009184 | Maxwell Edmund Whisson | Jan. 25, 2007 |
| WO2016081863A1 | Elise Switzer | May 26, 2016 |

### OTHER REFERENCES

1 Reginald Newell, Nicholas E. Newell, Yong Zhu, et al. Tropospheric Rivers?—A Pilot Study. Geophysical Research Letters. 1992, 19(242): 2401-2404
2 Mesfin M. Mekonnen, Arjen Y. Hoekstra. Four Billion People Facing Severe Water Scarcity. Science Advances. 2016, February 2(2): e1500323. Published on line 2016 Feb. 12. doi: 10:1126/sciavd 1500323.
3 Fernando T. Maestre, Roberto Salguero-Gomez and Jose L. Quero. It is getting hotter in here: determining and projecting the impacts of global environmental change on drylands. Philosophical Transactions of the royal society B. 2012, 367(1606): 3062-3075.
4 Zheng Chen, Weiguo Jiang, JianjunW, et al. Detection of the spatial patterns of water storage variation over China in recent 70 years. Scientific Reports 7, Article Number 6423 (2017) doi: 10.1038/s41598-017-06558-5
5 Donghyun Seo, Junghun Lee, Choongyepo Lee et al: The Effects of Surface Wettability on the Fog and Moisture Harvesting Performance on Tubular Surface. Sei Rep. 2016, 6: 24276.
6 Otto Klemm, Robert S. Schemenauer, Anne Lummerich, et al. Fog as a Fresh-Water Resource: Overview and Perspectives. AMINO 2012 41: 221-234. Dol 10 1007/s13280-012-0247-8.
7 Hyunho Kim, Sungwoo Yang, Sameer R. Raol, et al. Water Harvest from Air with Metal-organic Frameworks Powered by Natural Sunlight. Science 13 Apr. 2017:eaam 8743 dol: 10.1126/science. Aam8873
8 Gu Wei-zu, Chen Jian-Shen, Wang Ji, et al. Challenge from the Appearance of Vadose water within the Surface Layer of Mega Dunes, Badain Jaran Dune Desert, Inner Mongolia. Advances in Water Science. 2004, 115(16) 695-699 (Chinese with English Abstract).
9 Chen Jiansheng, Zhao Xia, Sheng Xiefen, et al. [Study on Formulation Mechanism of Lake Group and Sandy Mountain in Badain Jaran Desert] Chinese Science Bulletin. 2006, 51 (23): 2789-2796. (Chinese)
10 Din Hongwei, Guo Ri, Lan Yongchao, et al. Study on the Supplying Resource and Mode of lakes in the Badain Jaran Desert and the Formulation Mechanism of Mega Dunes. [J] Journal of Glaciology and Geocryology. (Chinese with English Abstract).
11 Liu Jiangang. Recharge Mechanisms of lake and groundwater in Badain Jaran Desert. Water Resources Protection. 2010, 26(2): 18-23. (Chinese with English Abstract).
12 Zhao Jingbo, Xing Shan, Shao Tianjie, et al. A Study on Content and Balance of Moisture in the Southern Tengger Desert. Journal of Natural Resources. 2012, 27(3). 480-488. (Chinese with English Abstract).
13 Zhao Jingbo, Shao Tianji, Hou Yule, et al. Moisture Content of Sand Layer and Its Origin in a Mega-Dune Area in the Badain Jarad Desert. Journal of Natural Resources. 2011, 26 (4): 694-702 (Chinese with English Abstract)
14 MaYandong, Zhao Jingbo, Luo Xiaoqing, et al. Runoff and Groundwater recharge Condition in the Megadune area of Badain Jaran Desert. ACTA Geographica Sinica, 2016 71 (3) 433-448. (Chinese with English Abstract).
15 Wang Tao. Formation and Evolution of Badain Jirin Sandy Desert, China. Journal of Desert Research 1990, 10 (1): 29-40. (Chinese with English abstract).
16 Sun Qing-feng Chen Fa-Hu, Li Xiao-ze. Review and discussion about progress of Quaternary Research of the Badain Juran Desert, China. Arid Zone Research, 2008, 25(2), 304-310 (Chinese with English Abstract).
17 Zhao Jingbo, Chen Zhiqing, Ma Yandong, et al. Film Moisture with High Content in Sand Layer and Its Movement in Mage-dune of Badian Jaran Desert. Scientia Geographica Sinica. 2017, 37(6): 960-966. (Chinese with English abstract).
18 Zhang Jing, Wang Xusheng, Hu Xiaonong, et al. Research in the Recharge of the lakes in the Badain Jaran Desert: Simulation Study in the Sumu Jaran Lakes area. J. Lake Sci. 2017, 29(2): 467-479. (Chinese with English abstract).
19 Zhang Jing, Wang Xusheng, Xiaonong, et al. The Macro-Characteristics of groundwater flow in the Badain Jaran Desert [J]. Journal of Desert Research, 2015, 35(3): 774-782. (Chinese with English abstract).
20 Ma Ning, Wang Naiang, Zhao Liqiang, et al. Observation of Mega-Dune Evaporation after Various Rain Events in the Hinterland of Badain Jaran Desert. Chin Scin SciBull, 2014, 59: 162-171. (Chinese with English abstract).
21 18 Hidden Waters: http://www.worldpolicy.org/sites/default/files/node_img/Split %20Map_0_jpg

### DESCRIPTION OF THE INVENTION FOR

### Field of the Invention

This invention is release a easy process of obtained the freshwater from atmosphere is suitable for almost everywhere of the nature conditions of the Earth conditions which the temperature change cyclically. Neither artificial energy not artificial green energy is need by said the process.

### BACKGROUND

Heated water on the earth surface can evaporate into air called vapor, it can also condensate back to the liquid and drop back to the surface of the ground called precipitation or rainfall. The water evaporated from the surface of the Earth is very huge [1], and there is about 3000 cubic miles and they are 98% of vapor and only 2% is the form of cloud. Usually the rainfall is thought the basic resource for the liquefaction freshwater. The liquid water can also leak down into the ground and be stored in aquifer layers underground. The freshwater stored aquifer can be long time or follow the sub-river underground flow up back to the ground some time, if terrain is in lower altitude, but finally, flow to the seas.

Fresh-water usually could mainly obtain from the rainfall (including snow), from rivers and lakes, or from the aquifers underground, as well as from the big salt lakes like sea and ocean by the Reverse Osmosis method. However, with the development of the social life, the human demands for water is quickly going up, the lack of water causes dry and thereafter cause the agriculture disasters and famine [2, 3, 4], and often due to the water demand caused by the war, even though people in various ways are trying to obtain freshwater to ease the shortage water plight [5, 6]

It has been for long tine of people try the ways to obtained water from air; the Thirties of last century, Knapen had applied for his patent for obtaining water from air, but it was less effective. Later, the related inventions were either need energy consumption, even if so called of ‘less energy utility’ like the nice one as U.S. Pat. No. 4,146,372A, or unnecessarily complicated for their good effects (U.S. Pat. Nos. 7,726,138B2, 2,761,292A), or, they were not suitable for large-scale application development of the arid land, like very nice scientifically invention reported [7]. My invention disclosed above a new viewpoint of the desert water generation. According to the viewpoint, its application for the freshwater generation is absolutely doesn't need any artificial energy to continuously obtained freshwater from nature condition, especially from desert condition. It just needs the air temperature exchanges between the inside and outside of the deserts layers.

### My New Viewpoint

The deserts can absorb atmosphere into their inside (see below), after the hot air is absorbed in the dunes and deserts and pass through the dry and hot sands which is called as the first shallow layer of the sands here (layer 1, see below) of the dunes and the deserts, the air then exposure to cold temperature in deeper sands layer (layer 2, see below) of the dunes and desert flatland, the air vapor is saturated and condensate on the surface of the sands and become film-water and then more and more because of the lower temperature compare with outside of the sand layer, and finally become gravity-water appearing in layer 3(see below), in which the water is full in the gaps between the sands and the saturated freshwater happened in the layer of 4 (see below). The water flows downward follow the gaps in these layers 3 and 4 of the sand-particles and therefore the freshwater current forms and it flows downward into the deeper of the dunes and the desert. The power for the absorption to the air mainly come from the freshwater currents flow downward following the gaps—like drain pipes between the sands by their gravity; it causes the negative air pressure which sucks the air from outside into the inside of desert flatland and dunes. In addition, air volume reduced from hot to cold are also supply the power to suck air from outside into the inside of the dunes. As the same time, the air's temperature is exchanged and reduced by the low air temperature of deeper sands and the sand-particle selves. Therefore, the humidity becomes larger and larger the water is condensed on the surface of the sand-particles as described above. At night time, cold air cools down the hot sands on the first shallow layer of the dunes and deserts by the cold water drops which is condensate from the air by cold temperature, and drench the sands cooling down to the same temperature with it. The cold temperature kept to the next day time into new cycle step. By this way, the freshwater is continually generated days and nights, millions of the years in the desert area and the freshwater leaking down into the deeper of the deserts and stored in aquifer layers.

Above cycles model is not only suitable for the fine sand partials dunes and desert areas, but also suitable for any other partials which is granules or spongy like ventilated objects, including made by artificial.

The temperature exchanges easily in well ventilating condition; in the case of the sand particles or the small stones are large enough in their sizes, the temperature exchange for the air vapor condensate is easily, for example, by wind, or by the water drops' own weight. So the effects of water-downward following the negative air pressure may not require in the process of the vapor precipitate to the freshwater in this situation. Also because the terrains are not the same, the water-downward negative air pressure is more important in the dunes and the edge portions of the basin and the mountains than the flat desert area.

Therefore, the freshwater is formed continually in the inside of the dunes and deserts, this is defined here as Internal Precipitation of the desert. And the hot and the cold air are sucked in desert periodic alternation results the freshwater generation is named here as the Desert's Breath or Respiration.

On the surface level of the desert, there always a layer 1 on day time, is dry and hot sands, because their air weight is different in the same volume in different temperatures, the cold air always flow downward and the hot air usually at the upper level in a receptacle, so even without the negative pressure caused by the precipitation water flow downward by the gravity, the cold air could also flow downward by its selves; slowly but surely, persistence of. On the other hands, the hot and warmer air always occupies upper level with hot dry in layer 1 of the desert, however, the sun's thermal of radiation interactions cannot direct affect the layer 2 of the desert which usually is wet, but the humidity is not up to the saturated yet. So above said the cold air in layer 2 should be protected by the first dry and hot sand in layer 1 of the deserts in day time, not mention to the negative are pressure said above.

In the night, the temperature drop down fast, the following events are the temperatures in air and sands in first layer cooled quickly too. The vapor condensation can direct happen in the air which are just in desert surface and in first layer of the desert: it is defined here as External Condensation Precipitation of the desert. Because in this time, by the heaver gravity, the cold air can direct continually flow downward into the deeper layer, so the cooling affect will continue into the sands of layer 2 for the new cycle of desert's breathing.

Therefore, hypothesis if the temperature changes are same in days in the same desert, then, according to their humidity, the thickness of the sands in desert could be simply divided into four layers from outside into the inside: layer 1, the temperature in this layer is dry and hot; humidity in here is the lowest. Layer 2, the temperature in here is lower than layer 1 and the humidity is higher than layer 1. The condensation starts appearing on the sands' surface become film-water, no gravity freshwater and its flowing appear here. Layer 3, humidity is saturated here and the precipitation appears in this layer, the freshwater flowing downward. Layer 4, the freshwater water flows on the up of the aquifuge or aquitarel, but this layer is not the aquifer layers—the aquifer layers can be thought as lakes underground.

Even if the changes is not easy to be seen, the thicknesses of the layers always changes in different temperature and different atmosphere humidity in same desert, and the changes are also depended on the thickness of total sands in different deserts and in different dunes—different terrains, also the edge portions of the basin and the mountains area. If the aquifuge is very deep, layer1 and 2 will be thicker and usually is more difficulty for plants and animals surviving. On the other side, the layer 1 and 2 even can combine together to one layer in night.

Because the temperature is always change by hours, and the air getting the desert and internal precipitation thereby also following the former's changes; that is, so this phenomenon of the varies of internal precipitation follow the Desert's Breath's change defined here as: “The Deserts' internal Tidal”.

Because the temperature is every hot in day time, usually the rainfall also can be absorbed by this layer, and the vapor form sands evaporation for the rainwater by the hot sand bodies' temperature and the high temperature following the rain, should also be sucked by above said negative air pressure. And also because the rainwater reduced temperature in layer 1 and bring up the humidity by the rainwater directly, so the amount of the internal precipitation will increase, but the effect of the internal precipitation is reduced. Of cause here, by no means deny the existence of the External Precipitation.

According to this released viewpoint, the dry air condition in the desert land is never because of the high temperature. It causes by the sands layer absorbing the moisture from air years and after. The desert areas are always raining in inside of the desert or the dunes.

There are always big different in temperature changes in every day and night in the deserts' area. The vapor condensation continually happened hours and hours, and years by years in inside and outside of the deserts. Also, because of the deserts area usually are large, the amount of the freshwater products should be very huge by this way, and it seems, already been provided by huge amount freshwater sources in the aquifers underground, always under the big deserts.

Also, this viewpoint will make big contribution in resolving the shortage water plight in future. By use a very simple method, it can collect freshwater: a large piled of sands which with fine/good ventilating condition, and a container under the stacked sands. Put them at the open place which the temperature changes big in day and night; collect water.

This is much cheaper way to getting freshwater from atmosphere compares with any other method referred above, and it doesn't need less-confidently to digging the very thick ground for wells and doesn't need spend much money and emerges and time to probe the water underground.

The freshwater from this way should be pure green and safety for the people's health and their living condition. By this way, human being will begin to completely conquer the desert, and will make big changes from the desert to the oases.

This new viewpoint can well explant many current phenomenon which confused people in science for years, especially in geology and geography, especially in the dunes in the Badain Jaran desert [BJD as below] area in the North of China: [15, 16]:

1, the precipitation is only 90-115 mm/y in South—East of BJD, but the evaporation is about 3500 mm/y [10, 19] and the water from springs support into more than 70 permanent lakes, and the spring water always flowing out in whole year [10]s; the water amount get from precipitation is much less than the amount from the springs [8]. The answer depend on my viewpoint is the most amount of the water is get from the desert's internal precipitation, despite of we cannot exclude the underground water resources in here, but the data and their analyses seems not support this surmise [13, 15, 19], at least the water from underground should not the main resource for the lakes' maintenance.

2, the testing result for the 180 isotopes in water from the dunes [8, 11], and the Deuterium testing result in the spring [11]. These can be explained by above [13]*.

3, the water level in the well is even 17 m higher than the water level in the lake only 200 m near by the well [9]. As the negative supporting of the water from confined-aquifer, the only answer for the water elevation is caused by said internal precipitation. This well and its water flowing can be direct prove for this new viewpoint! The evidence is the calcareous was found in same lake, the water is just 1 L/s, and not 17 m high. This is the negative evidence for the ideas of the water source is from confined-aquifer underground in BJD. Because if the water is flow out from underground, then, why the water level is 17 m high at the dunes near by the lake water level in the center of the calcareous? The only explanation for it is the water support from the dune's internal precipitation described above.

### Description for Invention Application,

### The Figure Marks

1, the air well which produce a negative air pressure for said the water generation system. And the negative air pressure will pass through all the parts of the installation including the sand-pile (sandy-particles) or any substitute which moisture could be condensed on its surface or inside.

2, the layer which is permeable for water but blocking the sands. In some simple design this may not need.

3, the air and water separating space in which the water and air are shunted here.

4, Diversion flume which let the water can flow into the water storage pool.

5, the water storage pool or water tank.

6 sands outlet at the low part of the air well which is for removal for the sand-dust deposition caused by Sandstorms. In some case it may not need.

7, the outlet pipe for water.

8, the pressure valve which can automatically open when the water-pressure in water tank is bigger enough

9, the outlet of the water tank.

10, the cover of the air well, which blocking the sand-dust get in the well because of the sandstorms.

11, the wind path or the direction of negative air pressure produced by air well.

12, the flowing direction of the condensed water with air.

13 the water flow.

14, the sand-pile or its substitute which moisture could be condensed on their surface or inside forming film-water and finally become gravity water.

15 the ground surface or the surface of the desert or dune.

16, the waterproof layer.

### BRIEF DESCRIPTION OF THE FIGURES

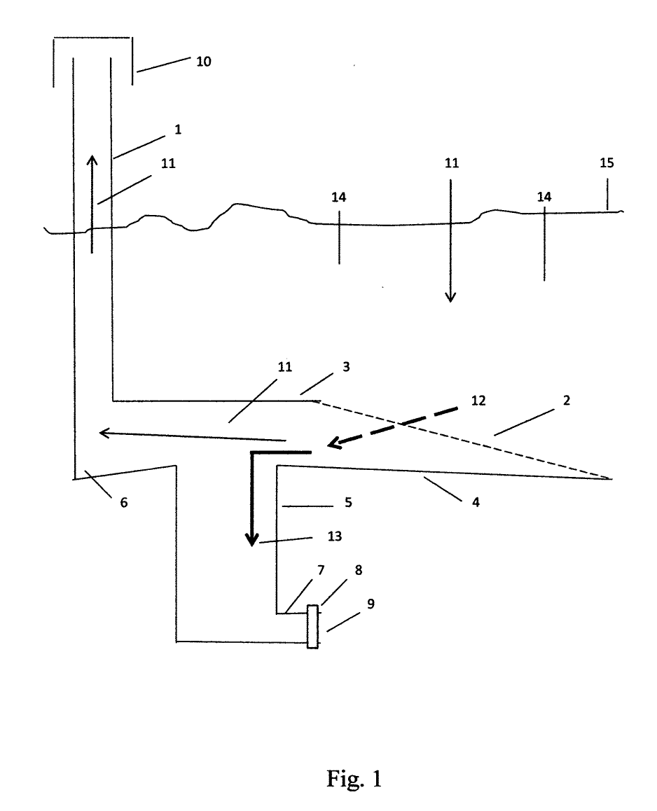

FIG. 1 shows the basic principle of the viewpoint's application.

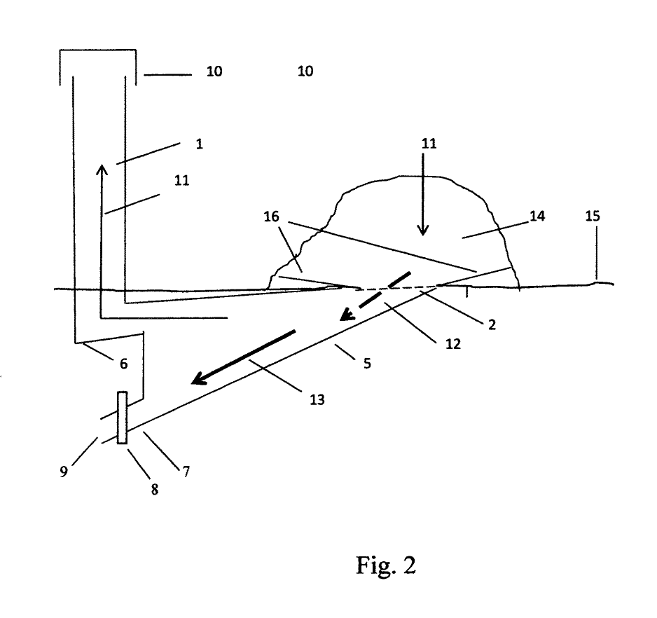

FIG. 2 shows one simple example (but never limited here) for the applications of the viewpoint.

### THE DETAILS OF THE INVENTION

### Examples 1

1, In the FIG. 1, the Air Well 1 will provide a Negative Air Pressure 11 for all parts of the water generation installation. In night time, following the negative pressure direction 11 and its own weight, the cold air passes through the Sand pile 14 which on the upper of the Diversion Flume 4 and the Layer 2. The sand pile will be completely cooled down by the cold air from outside of the sand pile 14 in the night. Also, the relatively wormer air in pores between grains of sands are exchange their temperature with the cold air and the moisture of the wormer air is condensed out to the surface of the sands till whole sand pile is completely cooling down, as well as the whole of the installation. On the day time, the hot air from the outside of the sand pile follow the negative pressure gets into the inside of the sand pile and exchanges the temperature with the cold sands and the air between the sands. The hot air exchanges its temperature with the sands and the cold air which already be cooled in night. In this time the air from outside of the sand pile becomes colder and colder and the moisture of the warm air is condensed and becomes the film water on the surface of the sands. And gradually, the film water condensed more and more following the depth of the sand-pile because of the low temperature keeping cooling condition and latterly, the unsaturated gravity water appears and finally, the saturated Gravity Water 12 appeared, too.

In the diversion flume 4, the space of 3, the air will be separated with Water 13 and sucked out by the negative air pressure caused by air well 1, and the water is collected in the Water Tank 5. So following the negative pressure circulation continually and the temperature change-cycles between the days and nights, the water is continually generated and flow into the water tank. After the water pressure reaches out of the control pressure index of the Shut-Off Valve 8, the valve will be opened automatically and the water will flow out by pass the Water Pipe 7 out of the Exit 9 of the water tank 5.

Because of the sandstorm are common in the desert condition, the annex of the air well; the Air Hood 10 is needed. Also the structure 6 of the air well is needed. But in the condition like seaside, however, both 10 and 6 may not be needed.

### Example 2

2, The FIG. 2, is also one (but never limited) of the application examples of said viewpoint: the following the negative pressure 11, the condensed water and air directly flow or are sucked in the water tank 5, in there the water 13 is separated with negative pressure airflow 11. In this case, the sand-pile 14 is above the ground surface 15, or is a dune. The Waterproof Layer 16 obviously, under the same condition, it will improve the efficiency of water production. So the approach in figure is more suitable for collecting freshwater at foot of the dune.

1. The principle and its application and method of obtaining freshwater directly from the atmosphere using the pressure difference and temperature difference of air by using of the sand-pile or any other substitute which moisture could be condensed on its surface or inside gaps.

2. the process according to the claim 1, said the method is the using of day and night temperature difference to achieve the sands at low temperature and low temperature regeneration by the airflow caused by negative pressure to pass through the gaps between the sand or substitute to obtain the condense freshwater.

3. the process according to the claim 1, said the pressure difference is supplied by using of the air well which generate a direction constantly negative air pressure and said the air well connects with the space in the sand-pile inside which the water can be flow to the store pool or tank and let the air can be sucked back-out from the sand-pile or its substitute which moisture could be condensed on its surface or inside.

4. the process according to the claim 3, said the direction constantly negative air pressure is means the direction constantly negative air pressure is from outside of the sand-pile into the inside of the sand-pile and pass through the space of the water pool and comeback to said the air well.

5. the process according to the claim 1, said the temperature different is based on the nature daily temperature changes between days and nights time and the temperature changes effect the air temperature changes and therefore cause the sand pile and it substitutes' temperature change following the temperature changed air which sucked in the sand pile and its substitutes.

6. the process according to the claim 1, said the sand-pile substitute means that the moisture could be condensed on their surface or inside gaps, which their permeability and water absorption are better, substitutions.

7. the process according to the claim 1, said the air well connects with a space which the water can be collected and let the negative pressure could pass through in order the air can back to the well from the sand-pile inside after the water is collected.

8. Any improvement changes of the application and methods for increasing freshwater production based on this principle are involved.

9. In claim 1 said the method can be used in anywhere of the Earth.
